(19) United States
(12) Patent Application Publication
(10) Pub. No.: US 2008/0061604 A1
(43) Pub. Date: Mar. 13, 2008

(54) Modular vehicle headliner

(76) Inventors: John M. Tiesler, Harrison Twp, MI (US); Jim Mestemaker, Lambertville, MI (US); David J. Cauvin, Brighton, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(21) Appl. No.: 11/519,365

(22) Filed: Sep. 12, 2006

(51) Int. Cl. B62D 25/06

(52) U.S. Cl. 296/214

(57) ABSTRACT

A modular vehicle headliner assembly includes a generally planar headliner substrate for mounting over an interior portion of a vehicle roof. An air duct is attached to one side of the substrate. An air-curtain assembly is attached to the air duct. The air duct supports the air-curtain assembly relative to the substrate.

### BACKGROUND OF THE INVENTION

This invention relates in general to headliners for installation into a vehicle interior, and in particular, to a modular vehicle headliner assembly.

Almost all roofed passenger vehicles have an interior headliner that includes one or more vehicle components. Many vehicle headliners are assembled with one or more vehicle components prior to installation into a vehicle. For example, U.S. Pat. No. 6,062,635 discloses plastic air duct integrated to a headliner. Also, U.S. Pat. No. 6,523,887 discloses a modular roof and headliner assembly including center and perimeter support mats with an air curtain assembly mounted to a portion of the perimeter support mat.

### BRIEF SUMMARY OF THE INVENTION

This invention relates to a modular vehicle headliner, including both an air duct and an air curtain assembly, for mounting over an interior portion of a vehicle roof.

The modular vehicle headliner assembly includes a generally planar headliner substrate. An air duct is attached to one side of the substrate. An air-curtain assembly is attached to the air duct. The air duct supports the air-curtain assembly relative to the substrate.

The invention also concerns a method of assembling such a headliner, and installing the headliner in a vehicle.

Various objects and advantages of this invention will become apparent to those skilled in the art from the following detailed description, when read in light of the accompanying drawings.

### BRIEF DESCRIPTION OF THE DRAWINGS

FIG. 1 is a perspective view of a modular vehicle headliner assembly according to a first embodiment of the present invention

FIG. 2 is a cross sectional view of the modular vehicle headliner assembly of FIG. 1 taken along line 2-2, and showing the modular vehicle headliner assembly being installed into a vehicle.

FIG. 3 is a view similar to FIG. 2 of a modular vehicle headliner assembly according to a second embodiment of the present invention shown being installed into a vehicle.

FIG. 4 is a flowchart illustrating a method for assembling a vehicle headliner module and installing the modular vehicle headliner assembly in a vehicle according to another embodiment of the present invention.

### DETAILED DESCRIPTION OF THE PREFERRED EMBODIMENT

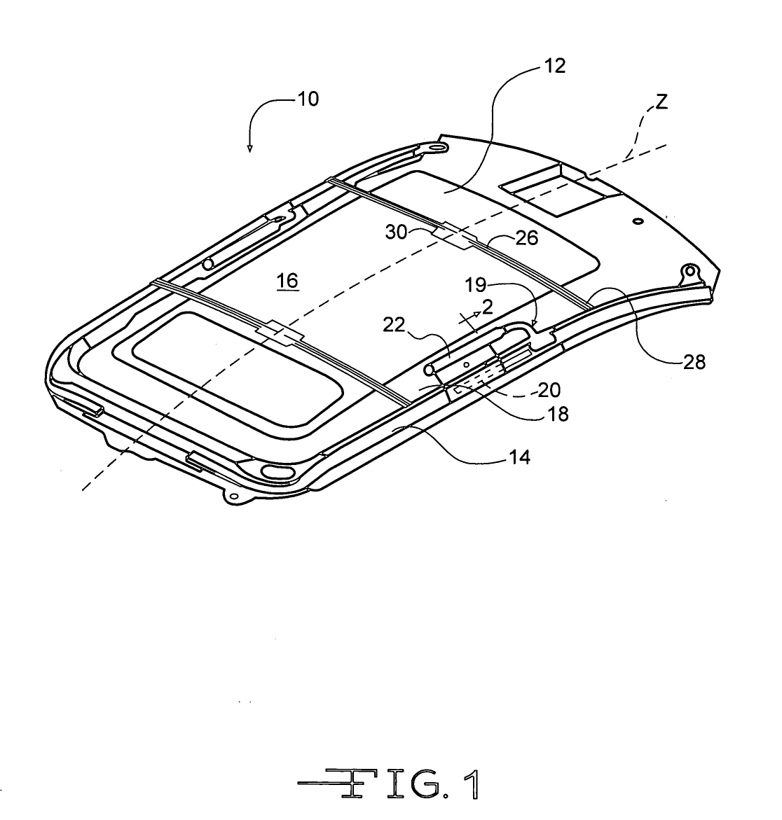

Referring now to the drawings, there is illustrated in FIG. 1 a modular vehicle headliner assembly 10 according to a first embodiment of the present invention. The exemplary headliner assembly 10 is generally symmetrical along a longitudinal vehicle axis Z. For the ease of description, it must be generally appreciated that when structure is described for the headliner assembly 10 similar corresponding structure exists symmetrically across the axis Z unless otherwise noted or shown. It must be understood however, that the headliner assembly 10 need not be symmetrical. In fact, the headliner assembly 10 may have any shape and/or configuration that is suitable for mounting in a vehicle.

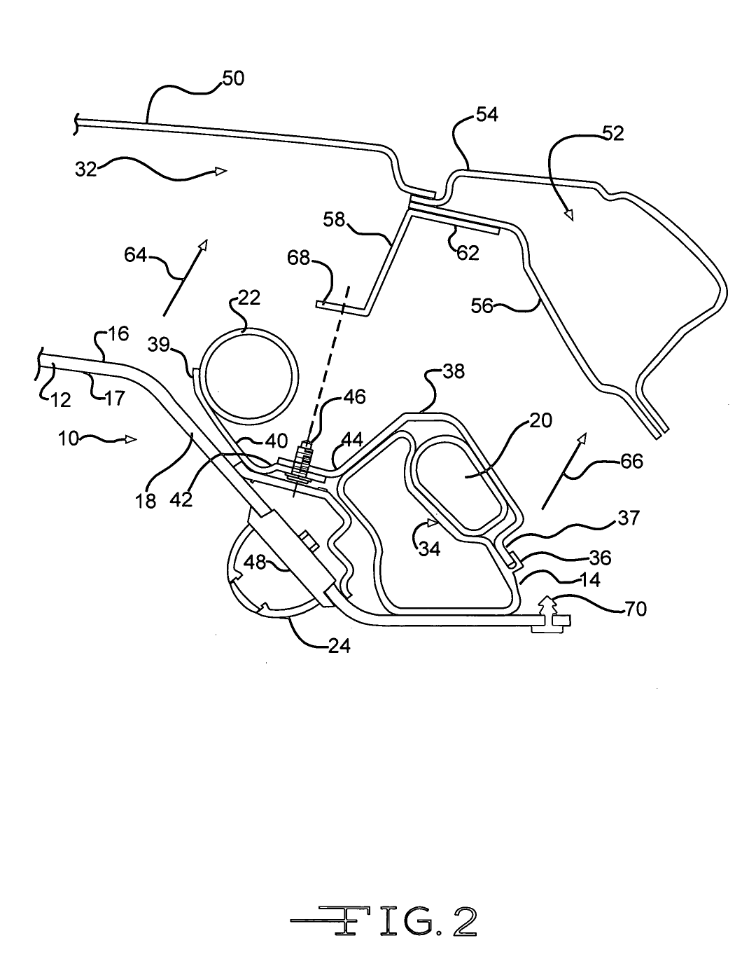

The modular vehicle headliner assembly 10 includes a generally planar headliner substrate 12. The headliner substrate 12 is suitable for mounting over an interior side of a portion of a vehicle roof, as will be described below. The substrate 12 has a first side 16 and a second side 17, as shown in FIG. 2. The substrate includes a perimeter support portion 18, although such is not required. The perimeter support portion 18 is reinforced or otherwise strengthened, in comparison to other portions of the substrate 12, as desired for supporting components attached to the perimeter support portion 18 relative to other portions of the substrate 12.

An air duct 14 is attached to the first side 16 of the headliner substrate 12. The air duct 14 is attached to the substrate 12 at the perimeter support portion 18. It must be understood, however, that the air duct 14 may be attached to any portion of the substrate 12 suitable for supporting the air duct 14. The air duct 14 is attached to the substrate 12 by hot melting. It must be understood, however, that the air duct 14 may be attached to the substrate 12 in any suitable manner. For example, the air duct 14 may be attached to the substrate 12 by welding, adhesive bonding, mechanical fastening, or any other manner suitable to attach the air duct 14 to the substrate 12 for use in a passenger vehicle. As shown, the air duct 14 is a multi-piece air duct. It must be understood, however, that the air duct 14 may be any suitable air duct, such as a one piece blow molded duct or any other duct suitable for the HVAC system of a vehicle.

A cross support 26 extends along the first side 16 of the headliner substrate 12. A first end 28 of the cross support 26 is attached to the air duct 14. The cross support 26 includes a component mount 30 for retaining a vehicle component relative to the substrate 12. For example, a video monitor (not shown) or a storage compartment (not shown) may be mounted on the second side 17 and attached to the component mount 30.

An air-curtain assembly 19 is attached to the air duct 14. The air duct 14 supports the air-curtain assembly 19 relative to the substrate 12. The air-curtain assembly 19 includes an inflatable air-curtain 20 and an air canister 22 for inflating the air-curtain 20.

As best shown in FIG. 2, a portion of the air duct 14 forms a recess 34. The recess 34 has a shape corresponding to the air-curtain 20, although such is not required. The air-curtain 20 is disposed in the recess 34. The air duct 14 includes an optional clip 36. The clip 36 is integrally formed in the exterior of the air duct 14. It must be understood, however, that the clip 36 by separately formed and then attached to the air duct 14. A first end 37 of a first bracket 38 engages the clip 36 to retain the air-curtain 20 to the air duct 14.

A first end 39 of a second bracket 40 is attached to the air canister 22. For example, the second bracket 40 may be welded to the air canister 22 or attached by any suitable mechanism to join the second bracket 40 to the air canister 22, so that the second bracket 40 may support the air canister 22. A second end 42 of the second bracket 40 is joined to a second end 44 of the first bracket 38. As shown, the first bracket 38 and the second bracket are joined by a torque fastener 46. It must be understood, however, that the first bracket 38 and the second bracket may be joined by any mechanism suitable to support the air-curtain assembly 19 relative to the air duct 14. For Example, the first bracket 38 and the second bracket may be welded, riveted, or joined by any other suitable manner.

A vehicle interior component 24 is mounted to the headliner substrate 12 on the second side 17. As shown, the vehicle interior component 24 is a passenger assist handle. It must be understood that the vehicle interior component 24 may be any vehicle component desired to be mounted to the interior roof of a vehicle. For example, the vehicle interior component may be a visor, a cargo latch, a coat hook, or any other vehicle component suitable for mounting to the interior roof of a vehicle.

As shown in FIG. 2, the vehicle interior component 24 is attached to the torque fastener 46 and supported by the perimeter support potion 18. It must be understood, however, that the vehicle interior component 24 may be joined into the modular vehicle headliner assembly 10 in any suitable manner. For example, the vehicle interior component 24 may be attached to and solely supported by the perimeter support potion 18. Alternatively, the vehicle interior component 24 may be attached to and supported by a vehicle frame member, not shown, by a bracket to other suitable device.

A trim cap 48 is provided through the vehicle interior component 24 to selectively allow access to the torque fastener 46 and cover the torque fastener 46

There is illustrated in FIG. 2 a portion of a vehicle roof, indicated generally at 32. The illustrated vehicle roof portion 32 is, in large measure, conventional in the art and is intended merely to illustrate one environment in which this invention may be used. Thus, the scope of this invention is not intended to be limited for use with the specific structure for the vehicle roof portion 32 illustrated in FIG. 2. On the contrary, as will become apparent below, this invention may be used in the environment of any suitable vehicle for the purposes described below.

The vehicle roof portion 32 includes a main roof section 50. The main roof section 50 is joined to a side roof section 52. As shown in FIG. 2, the side roof section 52 forms a vehicle doorjamb having and upper portion 54 and a lower portion 56. The main roof section 50 and the upper portion 54 and the lower portion 56 are joined by welding. It must be understood, however, that the roof section 50 and the upper portion 54 and the lower portion 56 may be joined in any manner suitable for constructing a vehicle, such as riveting, threaded fastening, or any other suitable manner.

A side rail bracket 58 is mounted to the vehicle roof portion 32. As shown in FIG. 2, the side rail bracket 58 is welded at a first end 60 to the lower portion 56. It must be understood, however, that the side rail bracket 58 may be attached to the vehicle roof portion 32 in any location and in any manner suitable for supporting the modular vehicle headliner assembly 10.

When the modular vehicle headliner assembly 10 is installed into the vehicle roof portion 32, as indicated by arrows 64 and 66, the torque fastener 46 engages a second end 68 of the side rail bracket 58 to secure the vehicle headliner assembly 10 relative to the vehicle roof portion 32. It must be understood, however, that the modular vehicle headliner assembly 10 may be installed into the vehicle roof portion 32 in any manner suitable to secure the modular vehicle headliner assembly 10 to the vehicle roof portion 32 for use in a vehicle. Optionally, barbed fasteners 70 may be attached to the perimeter of the headliner substrate 12 for securing the edge of the modular vehicle headliner assembly 10 to the lower portion 56 upon installation, although such is not required.

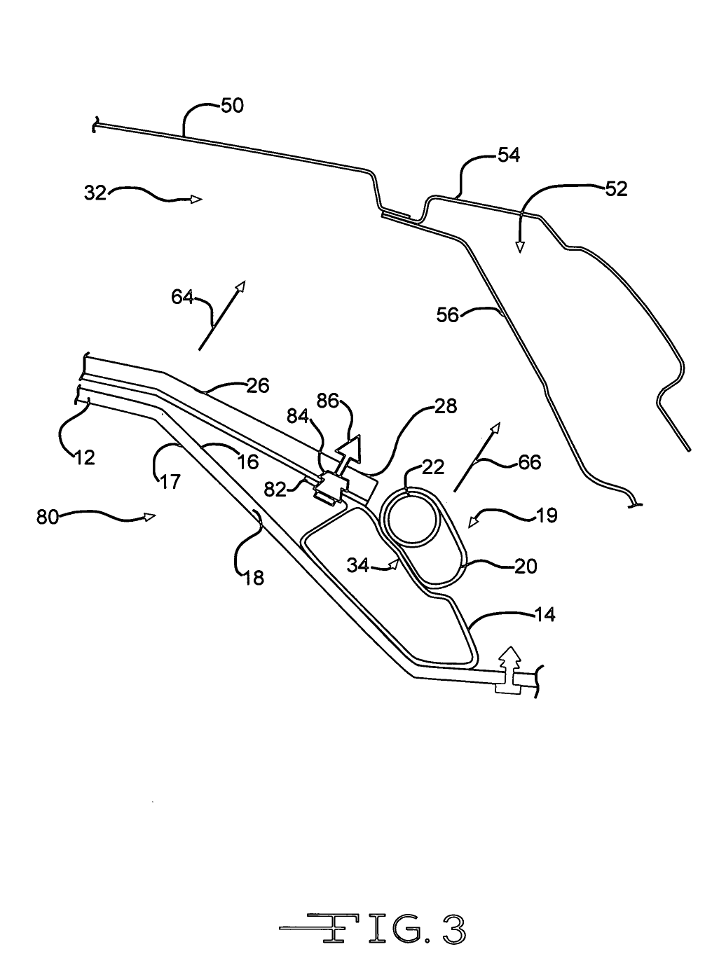

There is shown in FIG. 3 a modular vehicle headliner assembly 80 according to a second embodiment of the present invention, and similar components, as to FIGS. 1 and 2, are labeled with the same numbers.

The modular vehicle headliner assembly 80 includes a generally planar headliner substrate 12. The headliner substrate 12 is suitable for mounting over an interior side of a portion of a vehicle roof. The substrate 12 has a first side 16 and a second side 17. The substrate includes a perimeter support portion 18.

An air duct 14 is attached to the first side 16 of the headliner substrate 12. The air duct 14 is attached to the substrate 12 at the perimeter support portion 18.

A cross support 26 extends along the first side 16 of the headliner substrate 12. A first end 28 of the cross support 26 is attached to the air duct 14. As shown in FIG. 3, a tab 82 extends from the air duct 14. The tab 82 is integrally formed. It must be understood, however, that the tab 82 may be separately formed and attached to the air duct 14. A rivet 84 attaches the tab 82 to the first end 28 and thus secures the air duct 14 to the cross support 26. It must be understood, however, that the air duct 14 may be attached to the cross support 26 in any manner suitable to secure the air duct 14 and the cross support 26 together.

An air-curtain assembly 19 is attached to the air duct 14. The air duct 14 supports the air-curtain assembly 19 relative to the substrate 12. The air-curtain assembly 19 includes an inflatable air-curtain 20 and an integral air canister 22 for inflating the air-curtain 20.

A portion of the air duct 14 forms a recess 34. The recess 34 has a shape corresponding to the air-curtain assembly 19, although such is not required. The air-curtain assembly 19 is disposed in the recess 34. The air curtain assembly 19 is attached to the air duct by hot melting. It must be understood, however, that the air curtain assembly may be attached to the air duct 14 in any manner suitable to secure the air curtain assembly 19 to the air duct 14, such as welding or mechanical fastening.

There is illustrated in FIG. 3 a portion of a vehicle roof, indicated generally at 32. The vehicle roof portion 32 includes a main roof section 50. The main roof section 50 is joined to a side roof section 52. As shown in FIG. 3, the side roof section 52 forms an upper section of a vehicle pillar, such as a “B” pillar, having and upper portion 54 and a lower portion 56. The main roof section 50 and the upper portion 54 and the lower portion 56 are joined by welding.

When the modular vehicle headliner assembly 10 is installed into the vehicle roof portion 32, as indicated by arrows 64 and 66, a barbed fastener 86 attached to the cross support 26 engages the lower portion 56 to secure the vehicle headliner assembly 10 relative to the vehicle roof portion 32. It must be understood, however, that the modular vehicle headliner assembly 10 may be installed into the vehicle roof portion 32 in any manner suitable to secure the modular vehicle headliner assembly 10 to the vehicle roof portion 32 for use in a vehicle. Optionally, barbed fasteners 70 may be attached to the perimeter of the headliner substrate 12 for securing the edge of the modular vehicle headliner assembly 10 to the lower portion 56 upon installation, although such is not required.

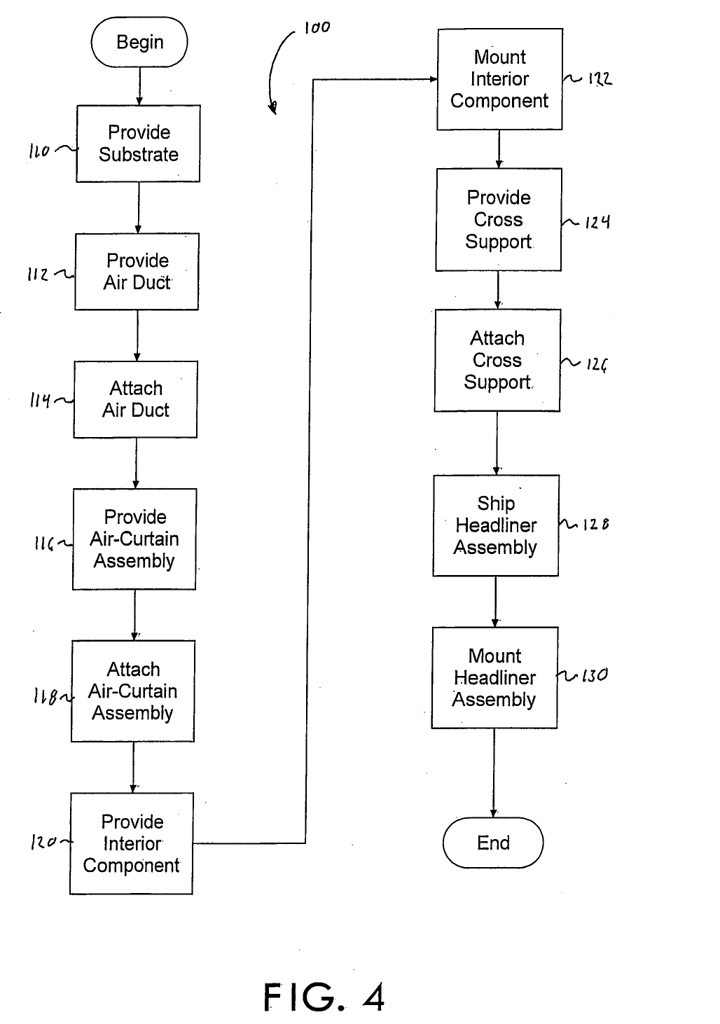

There is illustrated in FIG. 4 a method 100 for assembling a vehicle headliner module and installing the modular vehicle headliner assembly in a vehicle according to another embodiment of the present invention.

The method 100 begins in functional block 110 where a generally planar headliner substrate, defining first and second sides, for mounting over an interior portion of a vehicle roof is provided.

The method proceeds to functional block 112 where an air duct is provided.

The method then proceeds to functional block 114 where the air duct is attached to the first side of the substrate.

The method then proceeds to functional block 116 where an air-curtain assembly is provided.

The method then proceeds to functional block 118 where the air-curtain assembly is attached to the air duct.

The method then proceeds to functional block 120 where a vehicle interior component is provided.

The method then proceeds to functional block 122 where the vehicle interior component is mounted to the substrate on the one of the first and the second side of the substrate opposite the air duct

The method then proceeds to functional block 124 where a cross support is provided.

The method then proceeds to functional block 126 where a first end of the cross support is attached to the air duct.

The method then proceeds to functional block 128 where a modular vehicle headliner assembly, including the substrate, the air duct and the air-curtain, is shipped to a vehicle manufacturing plant.

The method then concludes in functional block 130 where the modular vehicle headliner assembly, is mounted in a vehicle

In one embodiment, a blow molded air duct is attached to a headliner substrate. The air duct is operable to provide HVAC air feed to the rear of a vehicle. An air curtain assembly is attached to the air duct. Cross support bows are also attached to the air duct. The integrated headliner substrate, air duct, and air curtain assembly for a modular headliner assembly.

In another embodiment, a modular headliner assembly includes a single torque fastener per side for mounting for the modular headliner assembly to an interior portion of a vehicle roof.

In one aspect, the present invention provides for improved vehicle assembly by eliminating a layer build of a headliner substrate and vehicle components, such as an air curtain assembly, at the vehicle manufacturing location.

In another aspect, the present invention provides improved installation of a vehicle headliner assembly into a portion of a vehicle by providing a single fastening attachment per side.

While the principle and mode of operation of this invention have been explained and illustrated with regard to particular embodiments, it must be understood, however, that this invention may be practiced otherwise than as specifically explained and illustrated without departing from its spirit or scope.

What is claimed is:

1. A modular vehicle headliner assembly comprising:
a generally planar flexible headliner substrate for mounting over an interior portion of a vehicle roof;
a rigid air duct attached to one side of said substrate; and
an air-curtain assembly including an air curtain component attached relative to said substrate, said air duct engageable with said air curtain component to securely support and position said air-curtain component relative to said substrate.

2. The assembly of claim 1 wherein said substrate includes a perimeter support portion, said air duct attached to said substrate at said perimeter support portion.

3. The assembly of claim 1 wherein said air-curtain component is one of an inflatable air-curtain and an air canister for inflating said air-curtain.

4. The assembly of claim 1 wherein said one side is a first side opposite a second side of said substrate, the assembly further comprising:
a vehicle interior mounted to said substrate on said second side.

5. The assembly of claim 4 wherein said vehicle interior component is one of an assist handle, a visor and a cargo/coat hook.

6. The assembly of claim 1 further comprising:
a cross support extending along said one side of said substrate, a first end of said cross support attached to said air duct.

7. The assembly of claim 1 wherein said cross support includes a component mount for retaining a vehicle component relative to said substrate.

8. The assembly of claim 1 wherein said air duct is a multi-piece air duct.

9. The assembly of claim 1 wherein said air duct is attached to said substrate by one of welding, hot melting, adhesive bonding, and mechanical fastening.

10. A method for assembling a vehicle headliner module and installing the modular vehicle headliner assembly in a vehicle comprising:
a. providing a generally planar headliner substrate for mounting over an interior portion of a vehicle roof, the substrate defining first and second sides;
b. providing an air duct;
c. attaching the air duct to the first side of the substrate;
d. providing an air-curtain assembly;
e. attaching the air-curtain assembly to the air duct; and
f. mounting the modular vehicle headliner assembly including the substrate, the air duct and the air-curtain in a vehicle.

11. The method of claim 10 further comprising step g., before step f., of:
g. shipping the modular vehicle headliner assembly from a vehicle headliner assembly plant to a vehicle manufacturing plant.

12. The method of claim 10 further comprising steps g. and h., before step f., of:
g. providing a vehicle interior component; and
h. mounting the vehicle interior component to the substrate on a side of the substrate opposite the air duct.

13. The method of claim 10 further comprising steps g. and h., before step f., of:
g. providing a cross support; and
h. attaching a first end of the cross support to the air duct.

14. The method of claim 10 wherein the attaching in step c. is one of welding, hot melting, adhesive bonding, and mechanical fastening.
